(19) United States
(12) Patent Application Publication
(10) Pub. No.: US 2025/0378413 A1
(43) Pub. Date: Dec. 11, 2025

(54) WORKER EVALUATION SYSTEM AND WORKER EVALUATION METHOD

(71) Applicant: Hitachi, Ltd., Tokyo (JP)

(72) Inventors: Haruka ITAGAKI, Tokyo (JP); Taichi SHIKAWA, Tokyo (JP)

(21) Appl. No.: 19/066,233

(22) Filed: Feb. 28, 2025

(30) Foreign Application Priority Data
Jun. 5, 2024 (JP) 2024-091293

(51) Int. Cl. G06Q 10/0639; G06Q 10/105

(52) U.S. Cl. CPC G06Q 10/06398; G06Q 10/105

(57) ABSTRACT

A system accepts input of worker specification information that specifies a worker to be analyzed, specifies specific object information of the worker, calculates individual performance of a work of the work for a specific object, and compares the individual performance and overall performance to calculate evaluation of the worker for the specific object. Further, the system specifies a similar specific object belonging to a classification similar to a classification to which the specific object belongs or a similar process of a specific object belonging to a classification similar to the classification to which the specific object belongs, and outputs individual evaluation, the similar specific object or the similar process.

### CROSS-REFERENCE TO PRIOR APPLICATION

This application relates to and claims the benefit of priority from Japanese Patent Application number 2024-091293, filed on Jun. 5, 2024 the entire disclosure of which is incorporated herein by reference.

### BACKGROUND

The present invention generally relates to a technology for evaluating workers.

As a technology regarding worker evaluation, for example, a technology disclosed in Japanese Patent Application No. 2017-225362 is known.

### SUMMARY

Evaluation of workers is useful for flexible human resource deployment planning and development of human resources based on strengths and weaknesses of the workers. It is desirable to improve evaluation accuracy of workers.

A system accepts input of worker specification information that specifies a worker to be analyzed, specifies specific object information of the worker, calculates individual performance of a work of the worker regarding the specific object, compares the individual performance with overall performance to calculate evaluation of the worker for the specific object. Further, the system specifies a similar specific object belonging to a classification similar to a classification to which the specific object belongs or a similar process of a specific object belonging to a classification similar to the classification to which the specific object belongs, and outputs individual evaluation, the similar specific object or the similar process.

According to the present invention, it is possible to provide information that can be utilized in flexible human resource deployment planning and information that can be utilized in development of human resources based on strengths and weaknesses of workers.

### BRIEF DESCRIPTION OF THE DRAWINGS

FIG. 1 illustrates an overall configuration example of a system including a worker evaluation system according to an embodiment;

FIG. 2 illustrates an example of a logical configuration of the worker evaluation system;

FIG. 3 illustrates an example of a structure of part of a process management model according to the embodiment;

FIG. 4 illustrates an example of data to be generated and referred to in evaluation processing according to the embodiment;

FIG. 5 indicates an example of flow of the evaluation processing according to the embodiment;

FIG. 6A illustrates an example of a positive evaluation UI;

FIG. 6B illustrates an example of a negative evaluation UI; and

FIG. 6C illustrates a modification of the evaluation UI.

### DESCRIPTION OF EMBODIMENTS

In the following description, an “interface apparatus” may be one or more interface devices. The one or more interface devices may be at least one of the following.
An input/output (I/O) interface apparatus that is one or more I/O interface devices. The input/output (I/O) interface device is an interface device for at least one of an I/O device or a remote computer for display. The I/O interface device for the computer for display may be a communication interface device. At least one I/O device may be one of user interface devices, for example, an input device such as a keyboard and a pointing device, and an output device such as a display device.
A communication interface apparatus that is one or more communication interface devices. The one or more communication interface devices may be one or more communication interface devices of the same type (for example, one or more network interface cards (NICs)) or may be two or more communication interface devices of different types (for example, an NIC and a host bus adapter (HBA)).

Further, in the following description, a “memory” is one or more memory devices that is an example of one or more storage devices and may be typically a main storage device. At least one memory device in the memory may be a volatile memory device or may be a non-volatile memory device.

Further, in the following description, a “persistent storage apparatus” may be one or more persistence storage devices that are an example of one or more storage devices. The persistence storage device may be typically a non-volatile storage device (for example, an auxiliary storage device) and may be specifically, for example, a hard disk drive (HDD), a solid state drive (SSD), a non-volatile memory express (NVME) drive or a storage class memory (SCM).

Further, in the following description, a “storage apparatus” may be at least a memory between the memory and the persistence storage apparatus.

Further, in the following description, a “processor” may be one or more processor devices. At least one processor device may be typically a microprocessor device such as a central processing unit (CPU), but may be other types of processor devices such as a graphics processing unit (GPU). At least one processor device may be a single-core processor device or a multi-core processor device. At least one processor device may be a processor core. At least one processor device may be a processor device in a broad sense such as a circuit that is an aggregate of gate arrays that perform part or all of processing using hardware description language (for example, a field-programmable gate array (FPGA), a complex programmable logic device (CPLD) or an application specific integrated circuit (ASIC)).

Further, in the following description, while a function may be described using expression of a “yyy unit”, the function may be implemented by one or more computer programs being executed by the processor or may be implemented by one or more hardware circuits (for example, an FPGA or an ASIC), or may be implemented by a combination thereof. In a case where the function is implemented by the program being executed by the processor, determined processing is performed using the storage apparatus and/or the interface apparatus, or the like, as appropriate, and thus, the function may be regarded as at least part of the processor. Processing described using a function as a subject may be regarded as processing that is performed by the processor or an apparatus including the processor. The program may be installed from a program source. The program source may be, for example, a storage medium (for example, a non-transitory storage medium) readable by a program distributing computer or a computer. Description of each function is an example, and a plurality of functions may be integrated into one function, or one function may be divided into a plurality of functions.

Further, in the following description, in a case where description is provided while elements of the same type are not distinguished, a common reference numeral among reference numerals may be used, and in a case where elements of the same type are distinguished, the reference numerals may be used.

Further, in the following description, “4M” means initial letters of four elements of worker (Man), Machine, Method and Material. In the following description, the four elements constituting “4M” will be expressed as “Man”, “Machine”, “Method” and “Material”, and these will be collectively referred to as a “4M element”.

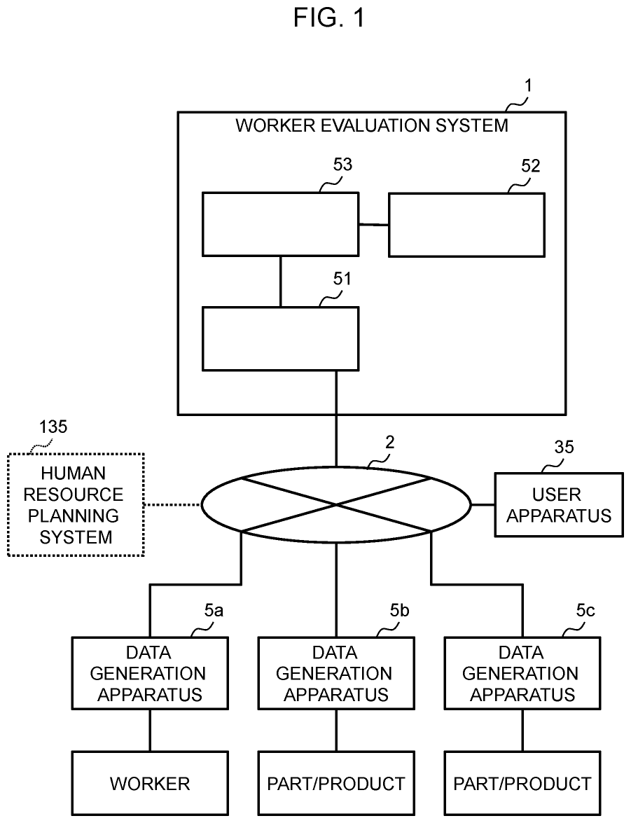

FIG. 1 illustrates an overall configuration example of a system including a worker evaluation system according to the embodiment.

In the present embodiment, a worker evaluation system 1 is a physical computer system (one or more physical computers) and includes an interface apparatus 51, a storage apparatus 52 and a processor 53 coupled to them. The worker evaluation system 1 may be a logical computer system (for example, a virtual machine or a cloud computing system) based on a physical computer system.

A network 2 (for example, the Internet or a wide area network (WAN)) is coupled to the interface apparatus 51. To the network 2, one or a plurality of data generation apparatuses 5 (for example, data generation apparatuses 5a to 5c) and a user apparatus 35 are coupled. The data generation apparatus 5 and the user apparatus 35 are coupled to the worker evaluation system 1 via the network 2.

The data generation apparatus 5 is an apparatus that collects or generate real data. For example, the data generation apparatus 5a may be a barcode reader that acquires a work log of a worker or a PC or a server that collects a work log. The data generation apparatus 5b may be a machine that processes parts or assembles a finished product. The data generation apparatus 5c may be a sensor that collects inspection information of a radio frequency identifier (RFID) attached to a part or a finished product. Real data collected or generated at the data generation apparatus 5 may be transmitted to the worker evaluation system 1 (and/or a storage apparatus coupled to the network 2 and existing outside the worker evaluation system 1) via the network 2. The “real data” may be data generated or collected on site (for example, manufacturing site) and particularly may be at least part of data regarding an entity belonging to a 4M element, for example, data regarding a facility belonging to Machine, data regarding a worker belonging to Man, data regarding a part or a product belonging to Material and data regarding procedure belonging to Method. Hereinafter, the entity belonging to the 4M element may be referred to as a “4M entity”.

The user apparatus 35 is an information processing apparatus (computer) like a personal computer or a smartphone. The worker evaluation system 1 may be a server, and the user apparatus 35 may be a client. The worker evaluation system 1 transmits evaluation result information that is information representing an evaluation result of the worker to the user apparatus 35, and the user apparatus 35 displays an evaluation UI that is a user interface (UI) of the evaluation result indicated in the evaluation result information. Further, in the present embodiment, the “user” may be a person in charge of human resource planning of workers or may be a person in charge of evaluation which will be described later. The “human resource planning” may include planning regarding to which process a worker is to be allocated.

Note that the worker evaluation system 1 may be communicably coupled to an external computer system (physical or logical planning system) like a human resource planning system 135 via the network 2. An example of the human resource planning system 135 will be described later.

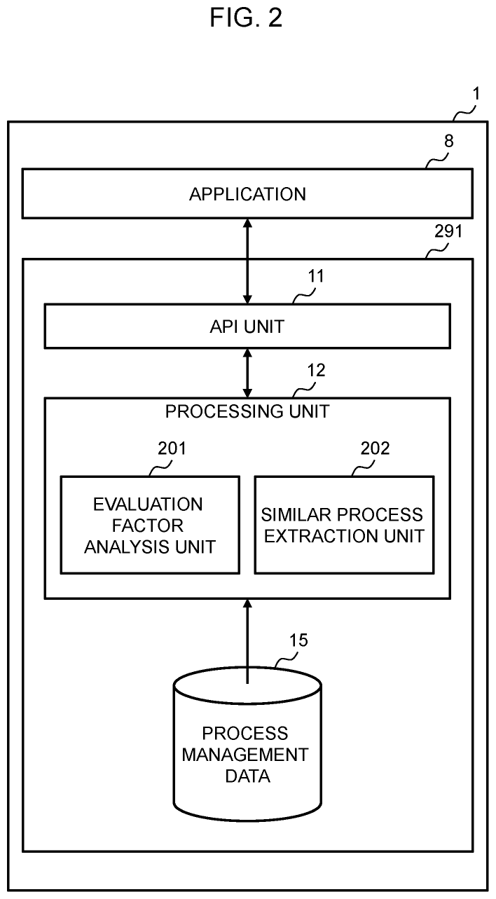

FIG. 2 illustrates an example of a logical configuration of the worker evaluation system 1.

For example, process management data 15 is stored in the storage apparatus 52 of the worker evaluation system 1. The process management data 15 includes data for each 4M entity (for example, data representing a process with which the 4M entity is involved, hours of a work or operation of the 4M entity, and a state of the 4M entity for each hour). In the present embodiment, the process management data 15 includes data representing a process management model which will be described later.

The worker evaluation system 1 includes a middleware 291 and an application 8, and the processor 53 executes these kinds of software. The application 8 may exist outside the worker evaluation system 1.

The middleware 291 includes an application programming interface (API) unit 11, and a processing unit 12. The middleware 291 may communicate with the user apparatus 35 by way of or without interposition of the application 8. In the latter case, the middleware 291 may include a user interface (UI) unit not illustrated, and the UI unit may communicate with the user apparatus 35.

The API unit 11 communicates with the application 8. The API unit 11, for example, accepts a first request from the application 8 and transmits a second request (for example, a request for executing evaluation processing) based on the first request to the processing unit 12. The API unit 11 receives a response to the second request from the processing unit 12 and returns to the application 8, a response to the first request from the application 8 based on the response.

The processing unit 12 accepts a request (for example, the second request) by way of the API unit 11 (or the UI unit), refers to or updates the process management data 15 based on the request and returns a response based on the result to a request source. The processing unit 12 includes an evaluation factor analysis unit 201 that analyzes an evaluation factor, and a similar process extraction unit 202 that extracts a similar process. These functions 201 and 202 will be described later.

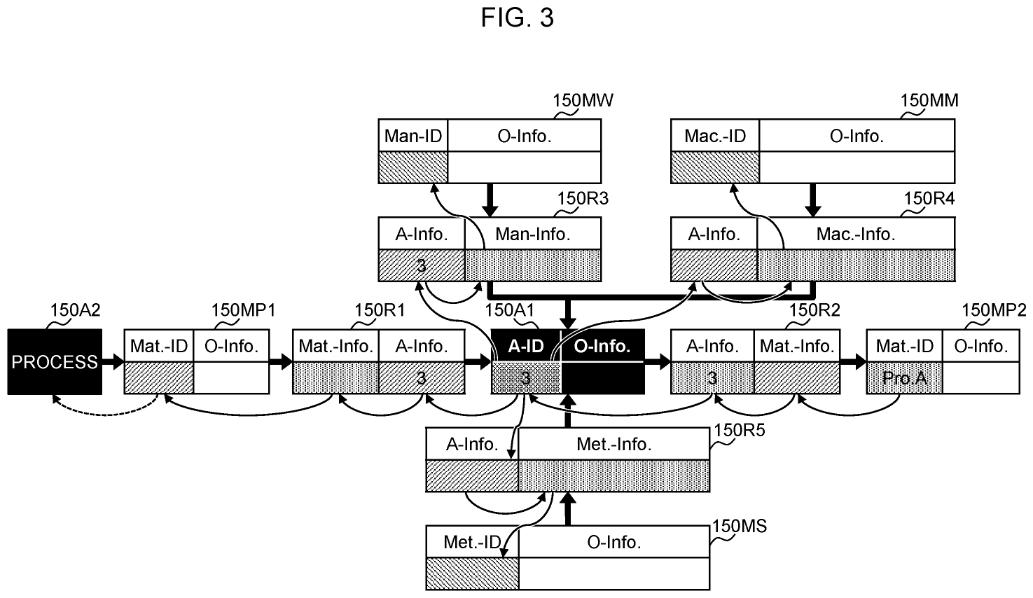

FIG. 3 illustrates an example of a data structure of part of the process management model indicated in the process management data 15.

The process management model represents order (flow) of a plurality of processes, and information regarding, for each of one or a plurality of 4M elements associated with individual processes, a 4M entity belonging to the 4M element.

Specifically, for example, the process management model is a graph including nodes 150 and edges. The edges in the graph may include an undirected edge, but typically, may be a directed edge. The process management model may be a directed acyclic graph (DAG).

The node 150 has information regarding a process, information regarding a 4M entity, and relation information for associating the information regarding the 4M entity with the information regarding the process. Hereinafter, the node 150 having the information regarding the process may be referred to as a “process node 150A”, the node 150 having the information regarding the 4M entity may be referred to as a “4M node 150M”, and the node 150 having the relation information may be referred to as a “relation node 150R”.

The information held by the process node 150A includes an A-ID (an ID of a process corresponding to the process node 150A) and O-Info. (information regarding operation of the process corresponding to the process node 150A). The O-Info. may include, for example, information representing when and what kind of operation is performed (for example, information including information representing a start time point and operating time of processing of a product for each product).

The information held by the 4M node 150M includes an ID of the 4M entity corresponding to the 4M node 150M and O-Info. as information regarding operation of the 4M entity corresponding to the 4M node 150M. The O-Info. may include, for example, information representing when and what kind of operation is performed (for example, information including information representing an operation start time point and an operation end time point for each operation or for each product). According to the example illustrated in FIG. 3, as the 4M node 150M, there are a Man node 150MW, a Machine node 150MM, a Material node 150MP, and a Method node 150MS. Further, according to the example illustrated in FIG. 3, as IDs of the 4M entity, there are a Man-ID (an ID of a worker), a Mac.-ID (an ID of a facility), a Mat.-ID (an ID of a part or a product), and a Met.-ID (an ID of procedure). For each 4M element, one 4M node 150M may be associated with one process node 150A, and the 4M node 150M may include an entity ID for each 4M entity (for example, for each of a worker A, a worker B, . . . ) belonging to the 4M element (for example, Man) or may exist for each 4M entity belonging to the 4M element.

The information held by the relation node 150R includes at least part (for example, at least an A-ID) of the information regarding the process, and at least part (for example, at least the 4M entity ID) of information regarding the 4M entity associated with the information regarding the process. Note that the 4M node 150M may be associated with the process node 150A by one edge without interposition of the relation node 150R, and the information held by the relation node 150R may be associated with the edge. The 4M node 150M of at least one 4M entity can be associated with one process node 150A by at least one relation node 150R.

In the example illustrated in FIG. 3, solid arrows are edges. Further, in the example illustrated in FIG. 3, curved solid or dashed arrows represent examples of directions of trajectories of information. For example, 4M nodes 150MP1, 150MP2, 150MW, 150MM and 150MS are associated with one process node 150A1 through relation nodes 150R1 to 150R5. The processing unit 12 specifies the relation nodes 150R1 to 150R5 using an A-ID of the process node 150A1 as a key and specifies the 4M nodes 150MP1, 150MP2, 150MW, 150MM and 150MS using IDs in the information of the relation nodes 150R1 to 150R5 as keys.

The user apparatus 35 may issue a request for worker evaluation to the application 8, and the API unit 11 of the middleware 291 may receive the request for executing worker evaluation from the application 8 that has received the request. The processing unit 12 may perform necessary tallying by tracing nodes in the process management model indicated in the process management data 15 in the designated unit or in accordance with the designated target (for example, a process, a 4M element or a 4M entity) with reference to the process management data 15 in response to the request received by the API unit 11, and may evaluate the worker using data as the tallying result. The processing unit 12 may generate data as the tallying result or may return evaluation result information representing the evaluation result of the worker to the application 8 through the API unit 11. The application 8 may transmit the evaluation result information received through the API unit 11 to the user apparatus 35.

The process management model and the user apparatus 35 may exist for each supplier. The processing unit 12 may evaluate the worker in the supplier based on the process management data 15 corresponding to the supplier in response to a request from the supplier and transmit evaluation result information representing a result of the evaluation to the user apparatus 35 of the supplier.

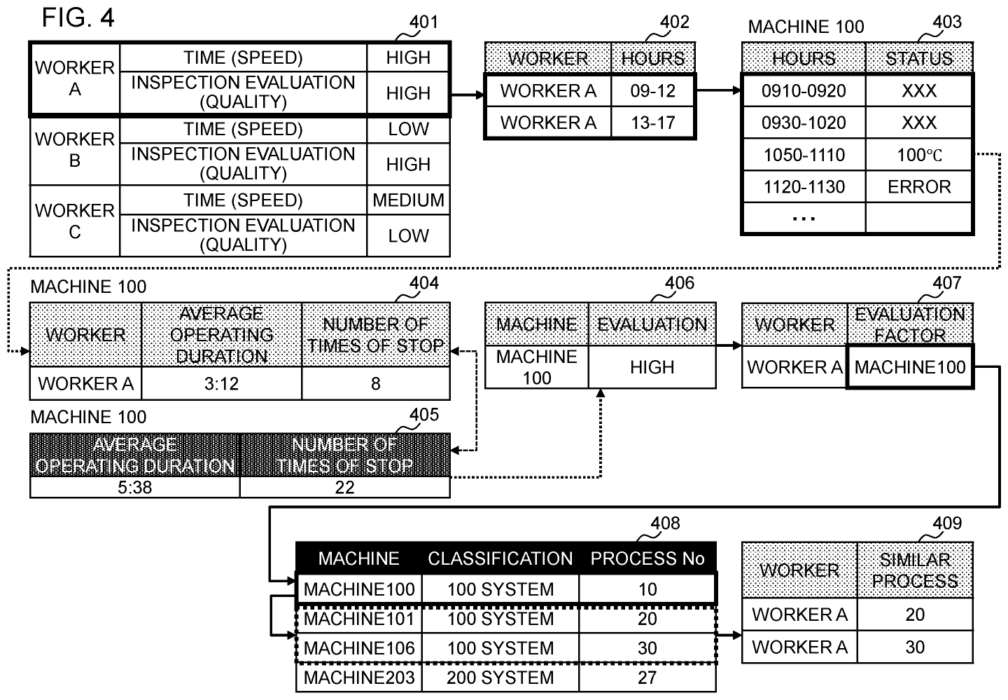

Evaluation processing according to the embodiment will be described below with reference to FIG. 4 and subsequent drawings. Note that in the following description, association of a first node with a second node via one edge can be expressed as “the first node belonging to the second node” or “the first node being directly associated with the second node”.

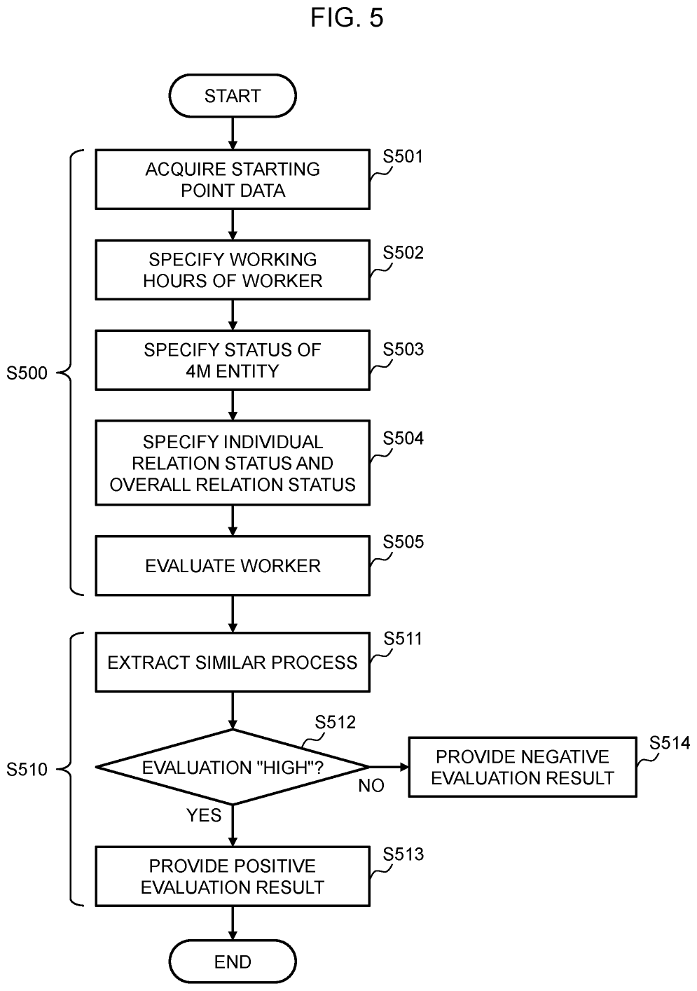

FIG. 4 illustrates an example of data to be generated and referred to in the evaluation processing. FIG. 5 indicates an example of flow of the evaluation processing according to the embodiment.

The evaluation processing is roughly divided into evaluation factor analysis (S500) and similar process extraction (S510). The evaluation factor analysis (S500) includes S501 to S505 and is performed by the evaluation factor analysis unit 201. The similar process extraction (S510) includes S511 to S514 and is performed by the similar process extraction unit 202. The respective kinds of processing will be described below.

The evaluation factor analysis unit 201 acquires starting point data (S501). The “starting point data” is a data source of the worker specified in this evaluation processing. The starting point data may be data representing the worker designated from the user through the user apparatus 35 (for example, a worker ID) or may be a list of workers. The workers described in the list may be workers specified by the evaluation factor analysis unit 201 from all Man nodes 150MW in the graph indicated in the process management data 15. As the list, an evaluation list 401 exemplified in FIG. 4 is employed. The evaluation list 401 is data representing evaluation items and evaluation for each evaluation item for each worker. Evaluation for each evaluation item may be evaluation by at least one of a human (for example, a person in charge of evaluation) or a computer. The evaluation list 401 may represent comprehensive evaluation of the worker for each worker. The following processing may be performed for each of the workers indicated in the evaluation list 401. Hereinafter, a worker A will be used as an example as a worker among the workers indicated in the evaluation list 401.

The evaluation factor analysis unit 201 specifies the worker A from the evaluation list 401 and specifies working hours of the worker A from the process management data 15 (S502). Specifically, for example, the evaluation factor analysis unit 201 specifies working hours of the worker A from O-Info. of all the Man nodes 150MW of the worker A (all the Man nodes 150MW specified using a worker ID of the worker A as a key). Hour data 402 exemplified in FIG. 4 is data obtained by the evaluation factor analysis unit 201 and data representing the specified working hours of the worker A.

The evaluation factor analysis unit 201 specifies one or more 4M entities for which a work or operation has been performed in the working hours of the worker A and specifies a work status or an operation status in hours overlapping with (for example, matching) the working hours of the worker A for each of the one or more 4M entities (S503). Each of the one or more 4M entities is specified by edges and the nodes 150 being traced using the Man node 150MW of the worker A as the starting point. For each of the one or more 4M entities, the work status or the operation status in the hours overlapping with the working hours of the worker A is specified from O-Info. of each node 150 specified using the Man node 150MW of the worker A as the starting point. The 4M entity for which a “work” has been performed may be any worker (Man), and the 4M entity for which “operation” has been performed may be any 4M entity (that is, Machine, Material or Method) other than the worker. In the example illustrated in FIG. 4, a machine “100” (machine having a facility ID of “machine 100”) is specified as the 4M entity for which “operation” has been performed. Status data 403 is data obtained by the evaluation factor analysis unit 201 and data representing an operation status of the machine “100” in hours overlapping with the working hours of the worker A. Hereinafter, the machine “100” will be used as an example of one 4M entity among “one or more 4M entities for which a work or operation has been performed in the working hours of the worker A”.

The evaluation factor analysis unit 201 specifies an individual relation status and an overall relation status of the machine “100” (S504). The individual relation status of the machine “100” is a relation status of the worker A (for example, an average of operating durations involving the worker A and the number of times of stop of the machine “100”) and is specified from O-Info. of the Machine node 150MM of the machine “100” or O-Info. of the Man node 150MW of the worker A directly associated with the process node 150A with which the Machine node 150MM of the machine “100” is directly associated. The overall relation status of the machine “100” is relation statuses of all workers involved with the machine “100” (for example, an average of operating durations and the number of times of stop of the machine “100”) and is specified from O-Info. of the Machine node 150MM of the machine “100” or O-Info. of the process node 150A with which the Machine node 150MM of the machine “100” is directly associated. Individual relation status data 404 exemplified in FIG. 4 is data representing the individual relation status of the machine “100”. Overall relation status data 405 is data representing the overall relation status of the machine “100”. Items of the individual relation status and the overall relation status may be common.

The evaluation factor analysis unit 201 specifies a degree of influence of the work of the worker A on operation of the machine “100” from the individual relation status of the machine “100” with respect to the overall relation status of the machine “100” and evaluates the worker A regarding the work on the machine “100” based on the degree of influence (S505). The degree of influence may be based on one or more ratios of individual relation statuses with respect to the overall relation status. The ratios may be calculated for each of the common items of the individual relation status and the overall relation status. Specifically, the ratios may include, for example, a first ratio that is a ratio of an average individual operating duration (average operating duration in the individual relation status) with respect to an average overall operating duration (average operating duration in the overall relation status) and a second ratio that is a ratio of the individual number of times of stop (the number of times of stop in the individual relation status) with respect to the overall number of times of stop (the number of times of stops in the overall relation status). For each of one or more ratios, the worker A may be evaluated from a relationship between the ratio and one or more thresholds for the ratio. For example, in a case where the first ratio and/or the second ratio is smaller than the threshold (that is, a duration involving the worker A is relatively short, and/or, the number of times of operation stop by the work of the worker A is relatively small), evaluation of the worker A may be set at “high”. Further, for example, in a case where the first ratio and/or the second ratio is equal to or larger than the threshold (that is, the duration involving the worker A is relatively long, and/or, the number of times of operation stop by the work of the worker A is relatively large), evaluation of the worker A may be set at “low”. The evaluation does not have to be two stages of “high” and “low” and may include multiple stages (for example, the evaluation may be scores). Evaluation result data 406 exemplified in FIG. 4 is data representing the evaluation of the worker A for the machine “100”.

The similar process extraction unit 202 extracts a process similar to the process to which the evaluation factor belongs for each evaluation factor of the worker A (S511). Specifically, for example, the similar process extraction unit 202 prepares evaluation factor data 407 representing evaluation factors of the worker A. The similar process extraction unit 202 specifies a classification of the evaluation factor and the process to which the evaluation factor belongs from the element management data 408 for each evaluation factor indicated in the evaluation factor data 407. The element management data 408 represents a classification of the element and a process to which the element belongs for each element (typically, a 4M element) that can be the evaluation factor of the worker. The classification of the element is an example of information for making a decision as to whether or not the processes are similar. The element management data 408 may be data tallied from the process management model indicated in the process management data 15. For example, for a machine that is an example of the element, the classification is specified from O-Info. of the Machine node 150MM of the machine, and the process is specified from an A-ID of the process node 150A with which the Machine node 150MM is associated. According to the example indicated in FIG. 4, the similar process extraction unit 202 specifies a classification “100 system” of the machine “100” and a process “10” to which the machine “100” belongs from the element management data 408 using the machine “100” that is an example of the evaluation factor of the worker A as a key. The similar process extraction unit 202 specifies other machines “101” and “106” in the same classification as the classification “100 system” of the machine “100” from the element management data 408. In the present embodiment, the machine in the same classification as the classification of the machine “100” is a similar machine of the machine “100”. The similar machine is an example of a similar element of the evaluation factor of the worker, and the similar element may be one or more 4M entities. The similar process extraction unit 202 specifies a process to which the similar machine belongs for each of the similar machines “101” and “106” from the element management data 408. As a result, processes “20” and “30” are specified. These processes “20” and “30” are similar processes of the process “10”. The similar process extraction unit 202 generates similar process data 409 that is a list representing the similar processes “20” and “30” specified for the worker A. According to this example, a process to which other factors in the same classification as the classification of the evaluation factor of the worker A (factors of the same type as the type of the evaluation factor) belong is extracted as a process similar to the process to which the evaluation factor of the worker A belongs (in other words, a process to which a similar element of the evaluation factor of the worker A belongs). The similar element or the similar process may be extracted using other methods.

The similar process extraction unit 202 makes an evaluation result to be provided to the user different in accordance with evaluation indicated in the evaluation result data 406 for each evaluation factor of the worker A. It is assumed that the evaluation factor is the machine “100”, and the evaluation includes two stages of “high” and “low”. The similar process extraction unit 202 determines whether or not the evaluation indicated in the evaluation result data 406 is “high” for the machine “100” (S512). In a case where the determination result in S512 is true (S512: Yes), the similar process extraction unit 202 provides a positive evaluation result (S513). In a case where the determination result in S512 is false (S512: No), the similar process extraction unit 202 provides a negative evaluation result (S514).

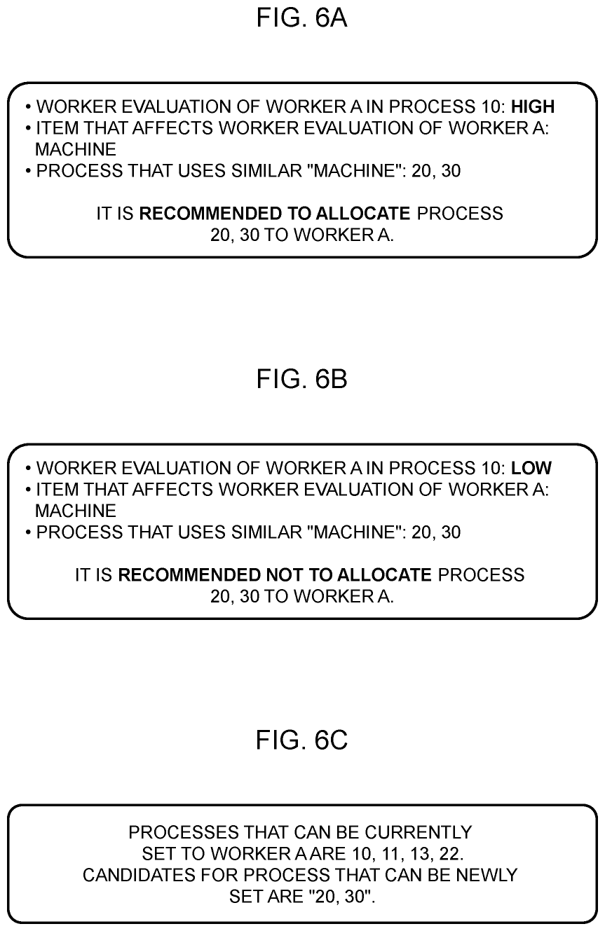

The “positive evaluation result” is a result that recommends to allocate the worker A to the extracted similar processes “20” and “30”. An example of provision of the positive determination result is transmission of positive data representing the positive evaluation result to the user apparatus 35 (that is, display of the positive evaluation result at the user apparatus 35). The positive data includes data indicating that a target worker is the worker A, that a type of the evaluation factor of the worker A is a machine (an example of the 4M entity), that the evaluation of the worker A for the evaluation factor (evaluation in S505) is “high”, that a process to which the machine “100” that is the evaluation factor belongs is the process “10”, that the similar processes are the processes “20” and “30”, and that it is recommended to allocate the worker A to the similar processes “20” and “30”. The user apparatus 35 displays a positive evaluation user interface (UI) that is a UI displaying content indicated in the positive data. An example of the positive evaluation UI is as illustrated in FIG. 6A.

The “negative evaluation result” is a result that recommends not to allocate the worker A to the extracted similar processes “20” and “30”. An example of provision of the negative evaluation result is transmission of negative data representing the negative evaluation result to the user apparatus 35. The negative data may be the same as the positive data except that the evaluation of the worker A for the evaluation factor of the worker A is “low”, and that data indicating that it is not recommended to allocate the worker A to the similar processes “20” and “30” is included. The user apparatus 35 displays the negative evaluation UI that is a UI displaying content indicated in the negative data. An example of the negative evaluation UI is as illustrated in FIG. 6B.

The evaluation UI displaying the evaluation result is not limited to the UI exemplified in FIG. 6A and FIG. 6B. For example, an evaluation UI exemplified in FIG. 6C may be displayed. In FIG. 6C, “processes that can be currently set to the worker A” may be all processes involving the machine “100” that is the evaluation factor of the worker A and may be processes specified from the element management data 408 by the similar process extraction unit 202. “Candidates for a process that can be newly set” may be similar processes of the process to which the machine “100” that is the evaluation factor of the worker A belongs (that is, the similar processes specified by the similar process extraction unit 202). According to the evaluation UI exemplified in FIG. 6C, neither the evaluation of the worker A (evaluation in S505) nor recommendation/non-recommendation of allocation of the worker A to the similar processes is displayed.

While an embodiment has been described above, this is an example for describing the present invention, and the scope of the present invention is not limited to this embodiment. The present invention can be executed in other various forms.

Note that the above description can be summarized, for example, as follows. The following summary may include supplementary description of the above description and description of modifications.

A worker evaluation system (for example, the worker evaluation system 100) includes an interface apparatus (for example, the interface apparatus 51) coupled to an external apparatus (for example, the user apparatus 35 or the human resource planning system 135), a storage apparatus (for example, the storage apparatus 52) that stores process management data (for example, the process management data 15) representing a plurality of processes, and a processor (for example, the processor 53) coupled to the storage apparatus. The process management data includes information representing, for each of the plurality of processes, a relation status that is a status of a work or operation in the process of a 4M entity for each 4M entity involved with the process. The 4M entity is an entity belonging to one of 4M (Man, Machine, Method, and Material). The 4M entity belonging to Man is a worker.

The processor specifies one or a plurality of 4M entities with which a target worker (worker to be evaluated) is involved from the process management data. The processor specifies, for each of the specified one or a plurality of 4M entities, an individual relation status (relation status by the target worker involved with the 4M entity) and an overall relation status (relation status by all workers involved with the 4M entity) from the process management data and determines evaluation of the target worker (for example, the worker A) using the 4M entity (for example, the machine “100”) as an evaluation factor from the individual relation status with respect to the overall relation status. The processor outputs evaluation result information that is information based on the determined evaluation of the target worker to the external apparatus through the interface apparatus.

In this manner, evaluation of the target worker is determined based on the individual relation status with respect to the overall relation status for the evaluation factor using the 4M entity with which the target worker is involved as the evaluation factor. It is therefore expected to improve evaluation accuracy of the worker.

Note that the “4M entity with which the target worker is involved” may be a 4M entity directly or indirectly associated with the target worker and may be specifically, for example, a 4M entity directly associated with a process with which the target worker is directly associated or may be a 4M entity for which hours of a work or operation overlap with hours of the target worker.

The processor may specify processes (for example the processes “20” and “30”) to which 4M entities (for example, the machine “101” and the machine “106”) similar to the 4M entity (for example, the machine “100”) belong from the process management data as similar processes of the process to which the 4M entity belongs for each of the one or a plurality of 4M entities specified for the target worker. The evaluation result information may include information representing the specified similar processes. This makes it possible to specify processes that can be candidates for a process to be allocated to the target worker from the evaluation result information.

The evaluation result information may include information representing a degree of recommendation to allocate or not to allocate the target worker to the specified similar processes, and the degree of recommendation may be a degree in accordance with the determined evaluation of the target worker. In this manner, the degree of recommendation to allocate or not to allocate the target worker to the similar processes becomes different in accordance with the evaluation of the target worker determined for the evaluation factor, so that determination as to whether or not to allocate the target worker to the similar processes becomes easy. For example, in a case where the determined evaluation of the target worker is relatively high, the degree of recommendation may be a degree of recommendation that recommends to allocate the target worker to the similar processes. In a case where the determined evaluation of the target worker is relatively low, the degree of recommendation may be a degree of recommendation that recommends not to allocate the target worker to the similar processes.

The external apparatus may be a user interface (UI) apparatus. The UI apparatus may be an input device and a display device or may be an information processing apparatus like the user apparatus 35. A UI displaying content indicated in the evaluation result information (for example, the UI exemplified in FIG. 6A or FIG. 6B) may be displayed at the UI apparatus. This enables the user to obtain evaluation of the target worker for the evaluation factor or information based on the evaluation.

The target worker may be a worker evaluated in advance (for example, any worker described in the evaluation list 401). The evaluation result information may include information representing evaluation performed in advance, the evaluation factor, and the determined evaluation for the evaluation factor. In this manner, a factor of the evaluation of the target worker performed in advance can be analyzed with a factor of the 4M entity, and thus, a reason for the evaluation performed in advance can be estimated. Further, the reason can be estimated in such a manner, so that evaluation accuracy of the worker is improved, and the evaluation result of the worker can be utilized in human resource planning (for example, planning that leads to development of human resources such as expansion of fields of the job of the worker).

While in the embodiment, the 4M entity as the evaluation factor is a machine, it is also possible to specify a 4M entity belonging to Material (for example, a part) or Method (for example, procedure) other than Machine using a worker (Man) as a starting point and determine evaluation of the target worker using such a 4M entity as the evaluation factor.

As items of the relation status, various items can be employed. For example, in a case where the 4M entity is a machine, the items are an average operating duration and the number of times of stop of the machine, but other items may be employed in place of or in addition to at least one of these items. In a case where the 4M entity is another worker, a type of a way of working, years of service, and the like, of the worker may be employed as the items. In a case where the 4M entity is procedure, an inspection result, a working duration, a degree of similarity to a video of the hands of an experienced worker, and the like, may be employed as the items. In a case where the 4M entity is a part, an inspection result of the part, an average working duration, and the like, may be employed as the items.

While in the embodiment, the processor performs evaluation using the 4M entity as the evaluation factor for each of all the 4M entities with which the target worker is involved, it is also possible to determine comprehensive evaluation based on the evaluation determined for each of all the 4M entities (for example, acquire an average value or a maximum value of the evaluation), set processes to which a similar 4M entity of the 4M entity with relatively high evaluation belongs as similar processes and output evaluation result information representing such similar processes and the comprehensive evaluation. For example, a process to which a similar 4M entity of a 4M entity (evaluation factor) for which the determined evaluation is relatively high belongs may be extracted as a similar process that the target worker is likely to be best at. The similar process that the target worker is likely to be best at is useful in allocation of the target worker. For example, the worker A obtains high evaluation for the process “10”, and it can be estimated as a result of evaluation factor analysis that the worker A is excellent with a machine and a part belonging to the process “10”. In this event, other processes (similar processes) to which machines and parts similar to the machine and the part belonging to the process “10” belong may be extracted. Further, if there is information in advance indicating that the target worker “places importance on handling a favorite “machine 2” in working”, similar processes may be extracted only for the machine. In this case, the “4M entity with which the target worker is involved” may be the 4M entity designated in advance by the target worker or may be the 4M entity specified from response paper submitted by the target worker. This makes it possible to newly propose a process pleasant for the target worker. Note that the processor may extract and propose a process that the target worker is not good at. Extraction of the process that the target worker is not good at enables grasping of skills that should be developed for the target worker as an organization.

The 4M entity similar to the comparison source (4M entity with which the target worker is involved) may be determined using an arbitrary method. For example, the similar 4M entity may be a 4M entity having a common predetermined type of attribute such as a classification with the comparison source or may be a 4M entity for which a distance of the attribute to the attribute of the comparison source is less than a predetermined distance.

Further, the similar process does not necessarily have to be extracted, and thus, the evaluation result information does not necessarily have to include information representing the similar process. Further, the evaluation result information may include information representing the similar process, but does not have to include information representing the determined evaluation itself (for example, FIG. 6C). Still further, in a case where the determined evaluation is relatively low, the evaluation result information may include information regarding another worker with relatively high determined evaluation (such as, for example, a video of the hands of the worker and a machine setting value).

Further, an example of the external apparatus may be the human resource planning system 135 exemplified in FIG. 1. The human resource planning system 135 may be a system that plans allocation of the worker to the process using the evaluation result information as input. The evaluation result information to be output may be information in a format that can be interpreted by the human resource planning system 135. The human resource planning system 135 may create a human resource plan that represents allocation of respective workers to processes based on whether allocation or non-allocation of the worker to the similar process is recommended by the evaluation result information based on the evaluation result information for each worker.

The plurality of processes may be processes for producing goods. A plurality of processes may be involved with goods of a plurality of different types. The “goods” may be any of parts, half-finished products and finished products.

The process management data may include, for each of the plurality of processes, process information including information regarding the process, and, for each of 4M entities (for example, directly) associated with the process, element information which includes information regarding the 4M entity and which is associated with the process information of the process. The process information may include information representing operation hours for each of goods, and the element information may include information representing work or operation hours. The processor may specify process hours that are hours of the process from the process information and specify the 4M entity corresponding to hours including the specified process hours from the element information associated with the process information. The above-described process management data 15 as an example of the process management data may represent a model constituted with a plurality of nodes and a plurality of edges, and the model may include, for each of the plurality of processes, a node having process information corresponding to the process and a node having element information associated with the process information. In the process management model illustrated in FIG. 3, the Man node 150MW (O-Info.) may include at least part of information representing an operating duration and information representing a skill set (for example, years of service and qualifications held) of the worker. The Machine node 150MM (O-Info.) may include at least part of information representing an operating duration (for example, between time points), information representing a facility setting value (for example, a mode) and information representing facility operation (for example, a measurement value by a sensor of the facility). The Method node 150MS (O-Info.) may include at least part of information representing an operating duration (for example, between time points), information representing a facility setting value (for example, a mode), and information representing an air conditioner setting value (inside a factory). The skill set of the worker (for example, a worker classification (for example, whether experienced or beginning) specified based on the skill set of the worker) may be used to specify a worker similar to the worker as the comparison source.

In the process management model illustrated in FIG. 3, processes may be created for each product and each type. Tallying may be performed based on the process management model illustrated in FIG. 3. In other words, the processing unit 12 may tally values regarding various items by tracing nodes and links using the IDs as keys starting from the process node 150A. The IDs to be used as the keys may be serial IDs for individuals or IDs provided in a unit of lot of individuals. The IDs include IDs of the process node 150A and each 4M node 150M, and the nodes and the links can be traced using the IDs of these as keys. Tallying may be performed in arbitrary unit (for example, in a unit of 4M element or in a unit of 4M entity).

The above description can be summarized, for example, as follows. The following summary may include supplementary description of the above description and description of modifications of the above-described embodiment.

A worker evaluation system (for example, the worker evaluation system 1) includes a calculation unit (for example, the processor 53), an input/output unit (for example, the interface apparatus 51 and the user apparatus 35), and a storage unit (for example, the storage apparatus 52). An example of the calculation unit may be the processing unit 12, an example of the input/output unit may be the API unit 11, and an example of the storage unit may be a storage area that stores the process management data.

The storage unit stores worker actual working information, overall performance information, and classification information. The worker actual working information is information in which a worker (for example, the worker A), a specific object (for example, the machine 100), and specific object information (for example, operation information such as stop and a machine temperature of the machine 100, information regarding a shape and characteristics of a part XXX, a type of procedure YYY or information regarding a partner zzz) that is information regarding the specific object (for example, the machine 100) related to the worker are associated. The overall performance information is information regarding overall performance of works of the workers for the specific object (for example, information regarding performance of operation of the machine 100 by all the workers). The classification information is information regarding a classification (for example, 100 system) to which the specific object (for example, the machine 100) belongs.

The input/output unit accepts input of the worker specification information (for example, the worker A) that specifies a worker to be analyzed.

The calculation unit specifies the specific object information (for example, operation information of the machine 100) of the worker (for example, the worker A) based on the worker specification information and the worker actual working information. The calculation unit calculates individual performance information that indicates performance of a work of the worker regarding the specific object (for example, performance regarding operation of the machine 100 by the worker A) based on the specific object information. The calculation unit compares the individual performance information and the overall performance information to calculate individual evaluation information that indicates evaluation of the worker for the specific object (for example, the machine 100 by the worker A evaluated as “high”). The calculation unit specifies a similar specific object (for example, the machine 101 or 106) belonging to a classification similar to the classification to which the specific object belongs or a similar process (for example, the process 20, the process 30) of a specific object belonging to a classification similar to the classification to which the specific object belongs, based on the classification information.

The input/output unit outputs the individual evaluation information (for example, the evaluation regarding operation of the machine 100 by the worker A as “high”), the similar specific object (for example, the machine 101 or 106) or the similar process (for example the process 20 or 30).

This makes it possible to provide information that can be utilized in flexible human resource deployment planning and information that can be utilized in development of human resources based on strengths and weaknesses of workers.

Note that an example of data including the worker actual working information, the overall performance information, and the classification information may be the process management data 15. At least part of the data including the worker actual working information, the overall performance information and the classification information may include information representing, for each of a plurality of processes, and for each of the 4M entities involved with the process, a relation status that is a status of a work or operation in the process of the 4M entity. The 4M entity may be an entity belonging to one of 4M (Man, Machine, Method and Material).

The “similar process” may be a process in the same classification as the classification to which the specific object belongs or a process in a classification incorporating the classification to which the specific object belongs. For example, if the classification of the machine 100 is “101”, the similar process may represent another process in the classification “101” or, in a case where “101” that is the classification of the machine 100 is incorporated into the 100 system, the similar process may represent another process having the classification of the 100 system.

The individual evaluation information may include information representing a degree of recommendation that recommends to allocate or not to allocate the worker to the similar process. The degree of recommendation may be a degree in accordance with the calculated evaluation of the worker. In this manner, the degree of recommendation that recommends to allocate or not to allocate the worker to the similar process is different in accordance with the evaluation of the worker calculated for the evaluation factor, so that determination as to whether or not to allocate the worker to the similar process becomes easy. Specifically, for example, in a case where the determined evaluation of the worker is relatively high, the degree of recommendation may be a degree of recommendation that recommends to allocate the worker to the similar process. In a case where the determined evaluation of the worker is relatively low, the degree of recommendation may be a degree of recommendation that recommends not to allocate the worker to the similar process.

The worker may be a worker evaluated in advance. The individual evaluation information may include information representing evaluation performed in advance, the evaluation factor, and the evaluation calculated for the evaluation factor. In this manner, the factor of the evaluation of the worker performed in advance can be analyzed, so that a reason of the evaluation performed in advance can be estimated. Further, the reason can be estimated in such a manner, so that evaluation accuracy of the worker is improved, and the worker evaluation result can be utilized in flexible human resource deployment planning and development of human resources based on strengths and weaknesses of the worker.

The calculation unit may calculate individual evaluation information for a plurality of specific objects. The input/output unit may accept designation of a specific object to which the worker assigns high priority. The calculation unit may extract a specific object or a process in a classification similar to a classification to which the specific object designated as having relatively high priority belongs among specific objects to which relatively high individual evaluation is provided. For example, the input/output unit may accept in advance designation of the 4M that each worker desires to prioritize, and the calculation unit may calculate evaluation result information for a plurality of 4Ms and output a classification to which the specific object designated as having relatively high priority belongs among the specific objects to which relatively high individual evaluation is provided. This makes it possible to newly propose a process pleasant for the worker.

1. A worker evaluation system comprising:
a calculation unit;
an input/output unit; and
a storage unit, wherein
the storage unit stores:
worker actual working information in which a worker, a specific object, and specific object information that is information regarding a specific object related to a worker are associated;
overall performance information regarding overall performance of works of workers for the specific object; and
classification information that is information regarding a classification to which the specific object belongs,
the input/output unit
accepts input of worker specification information that specifies a worker to be analyzed,
the calculation unit
specifies specific object information of the worker based on the worker specification information and the worker actual working information,
calculates individual performance information that indicates performance of a work of the worker regarding the specific object based on the specific object information,
compares the individual performance information and the overall performance information to calculate individual evaluation information that indicates evaluation of the worker for the specific object, and
specifies a similar specific object belonging to a classification similar to the classification to which the specific object belongs or a similar process of a specific object belonging to a classification similar to the classification to which the specific object belongs, based on classification information, and
the input/output unit
outputs the individual evaluation information and the similar specific object or the similar process.

2. The worker evaluation system according to claim 1, wherein the similar process is a process in the same classification as the classification to which the specific object belongs or a process in a classification incorporating the classification to which the specific object belongs.

3. The worker evaluation system according to claim 1, wherein
the individual evaluation information includes information representing a degree of recommendation that recommends to allocate or not to allocate the worker to the similar process, and
the degree of recommendation is a degree in accordance with the calculated evaluation of the worker.

4. The worker evaluation system according to claim 3, wherein
in a case where the determined evaluation of the worker is relatively high, the degree of recommendation is a degree of how recommendable it is to allocate the worker to the similar process, and
in a case where the determined evaluation of the worker is relatively low, the degree of recommendation is a degree of how recommendable it is not to allocate the worker to the similar process.

5. The worker evaluation system according to claim 1, wherein
the worker is a worker evaluated in advance, and
the individual evaluation information includes information representing evaluation performed in advance, the evaluation factor, and the evaluation determined for the evaluation factor.

6. The worker evaluation system according to claim 1, wherein
the calculation unit calculates the individual evaluation information for a plurality of specific objects,
the input/output unit accepts designation of a specific object to which the worker assigns high priority, and
the calculation unit extracts a specific object or a process in a classification similar to a classification to which a specific object designated as having relatively high priority belongs among specific objects to which relatively high individual evaluation is provided.

7. A worker evaluation method to be performed by a computer, the worker evaluation method comprising:
accepting input of worker specification information that specifies a worker to be analyzed;
specifying specific object information of the worker based on worker specification information and worker actual working information;
the worker actual working information being information in which a worker, a specific object, and specific object information that is information regarding a specific object related to a worker are associated,
calculating individual performance information that indicates performance of a work of the worker regarding the specific object based on the specific object information;
comparing the individual performance information and overall performance information to calculate individual evaluation information that indicates evaluation of the worker for the specific object;
the overall performance information being information regarding overall performance of works of workers for the specific object,
specifying a similar specific object belonging to a classification similar to a classification to which the specific object belongs or a similar process of a specific object belonging to a classification similar to the classification to which the specific object belongs, based on classification information that is information regarding the classification to which the specific object belongs; and
outputting the individual evaluation information and the similar specific object or the similar process.

8. A recording medium recording a computer program that causes a computer to execute:
accepting input of worker specification information that specifies a worker to be analyzed;
specifying specific object information of the worker based on worker specification information and worker actual working information;
the worker actual working information being information in which a worker, a specific object, and specific object information that is information regarding a specific object related to a worker are associated,
calculating individual performance information that indicates performance of a work of the worker for the specific object based on the specific object information;
comparing the individual performance information and overall performance information to calculate individual evaluation information that indicates evaluation of the worker for the specific object,
the overall performance information being information regarding overall performance of works of workers for the specific object,
specifying a similar specific object belonging to a classification similar to a classification to which the specific object belongs or a similar process of a specific object belonging to a classification similar to the classification to which the specific object belongs, based on classification information that is information regarding the classification to which the specific object belongs; and
outputting the individual evaluation information and the similar specific object or the similar process.
